(19) United States
(12) Patent Application Publication
(10) Pub. No.: US 2007/0005743 A1
(43) Pub. Date: Jan. 4, 2007

(54) Signal-type dependent real-time fax relay

(75) Inventor: Eyal Herzog, Tel Aviv (IL)

Correspondence Address: TIAJOLOFF & KELLY, CHRYSLER BUILDING, 37TH FL, 405 LEXINGTON AVE, NEW YORK, NY, 10174, US

(73) Assignee: Metacafe Inc., Wilmington, DE (US)

(21) Appl. No.: 11/173,183

(22) Filed: Jul. 1, 2005

(51) Int. Cl. G06F 15/173

(52) U.S. Cl. 709/223

(57) ABSTRACT

An apparatus and method may enable the controlled pushing of selected content to a plurality of user computers. A system may include a server that includes a push engine to enable automatic pushing of selected content between the user computers according to previously configured user preferences. The system may include a community of user computers, each user computer including a peer-to-peer engine to facilitate peer-to-peer file transfers directly between the user computers, each user computer further including a client application to enable the peer-to-peer file transfers to be managed by the system server such that selected content is pushed between the user computers according to the previously configured user preferences.

### FIELD OF THE INVENTION

The present invention relates to methods and devices useful in distributing digital content. Specifically, embodiments of the present invention relate to systems, methods and apparatuses that provide Peer-to-Peer distribution of digital content.

### BACKGROUND OF THE INVENTION

Peer-to-Peer (PSP) networks have evolved and expanded greatly, in parallel to the expansion and development of the Internet. Pure P2P file transfer networks do not have the notion of clients or servers, but only equal peer nodes that may simultaneously function as both “clients” and “servers” to the other nodes on the network. This model of network arrangement differs from the client-server model where communication is usually to and from a central server. P2P networks are often used for sharing content like audio, video, data or anything in digital format.

Typical usage of P2P file transfer networks includes searching, streaming and buffering data files from one node to another. Since these data files are often multimedia files, the distribution of such data between nodes is often characterized by significant delays in accessing data, and substantial slowing of network traffic.

### SUMMARY OF THE INVENTION

There is provided, in accordance with an embodiment of the present invention, an apparatus, system, and method for controlling the distribution of content to a plurality of user computers. The system may include a server that includes a push engine to enable automatic pushing of selected content between the user computers according to previously configured user preferences. The system may include a community of user computers, each user computer including a peer-to-peer engine to facilitate peer-to-peer file transfers directly between the user computers, each user computer further including a client application to enable the peer-to-peer file transfers to be managed by the system server such that selected content is pushed between the user computers according to the previously configured user preferences.

According to some embodiments of the present invention, a method is provided for digital content distribution, the method including entering user preferences to a server computer, the preferences being for filtering content to be received by the user in a peer-to-peer network; requesting content files from the server computer, by a client application on a user computer, according to the user preferences; sending to the user computer data including a list of selected content to be sent to the user computer; and pushing the selected content to the user computer from one or more other user computers, according to the previously configured user preferences.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic block diagram of a P2P network, according to some embodiments of the present invention;

FIGS. 2A and 2B are screenshots that indicate various functions and features, according to some embodiments of the present invention;

FIG. 3 is a schematic block diagram of a server farm and client machine, according to some embodiments of the present invention;

FIG. 4 is a is a schematic block diagram illustrating DII modules in a client machine, according to some embodiments of the present invention; and

FIG. 5 is a flowchart illustrating a method of file transfer, according to some embodiments of the present invention.

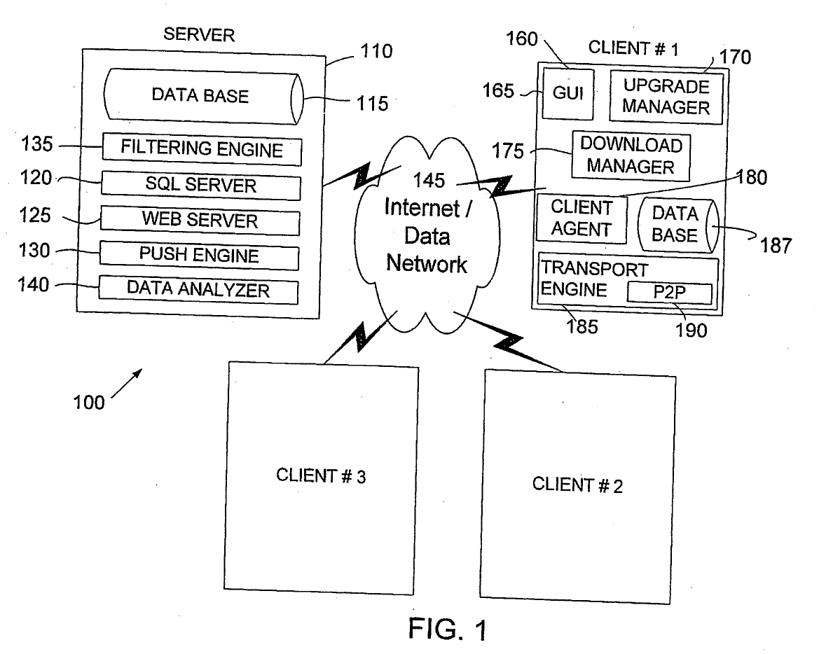

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The platforms, processes and displays presented herein are not inherently related to any particular computer or other apparatus. Various general-purpose computing systems and networking equipment may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the present invention as described herein.

In the following detailed description, numerous specific details are set forth in order to provide a thorough understanding of the present invention. However, it will be understood by those skilled in the art that the present invention may be practiced without these specific details.

The word “P2P” as used herein may encompass any network wherein data may be received and served by a plurality of end nodes. Such a network may include “pure” P2P networks, where no dedicated “server” computers are used, “non pure” networks, where dedicated “server” computers may be used, and other networks where file transfers between computers may be used. The word “push” as used in “push technology”, “pushing data” etc. as used herein, may encompass any data distribution technology in which selected data is automatically delivered into a user's computer, for example, at prescribed intervals or based on some event that occurs.

Reference is now made to Fig. I, which illustrates a distribution platform for digital content, according to some embodiments of the present invention. System 100 may include server 110, data network 145 and a plurality of clients including client applications 160. Server 10 may include one or more server engines, for example, SQL server engine 120, to control server operations. For example, server engine 120 may enable data to be communicated between a plurality of users and server 110, to help in managing a community of users. Server 110 may include one or more databases (DB) 115, for example, SQL databases. DB 115 may include user data, content or item data, content metadata (e.g., channel data, rank data, viewing data, link data, user-comments, submitter data, hash code data, filename data, file-type data, frame/per-second data, content history data etc.), codec data, resolution data, subscription data, filter data, submission data, forwarding request data, user and system Statistics etc.

Server 110 may include one or more Web application servers 125. Each Web application server 125 may enable serving of data between server 110 and a plurality of users. For example, the Web Application server 125 may enable downloading of client applications, receipt of client data, configuration of user preferences, execution of client application etc.

Server 110 may include a data pushing or push engine 130 to control the pushing or delivery of content directly to a plurality of users according to individual and/or group user preferences. For example, server 110 may distribute selected content to users according to the user's preferences, for example, depending on selected channels, restrictions, rankings, types, keywords, formats, and language etc. In one example, users may customize the way content is delivered using channels and filters, thereby providing quality content to users without actively searching and without the discomfort of streaming or buffering.

Server 110 may include a filtering engine 135, for example, to enable effective filtering of content, as is described in detail below.

Server 110 may provide a scalable layered server-side infrastructure that may support a Windows client handling both peer to peer enabled downloads and server downloads. Advanced collaborative filtering methods may track users' interactions with media to effectively filter content and provide top rated media first. User resource management is handled by controlling bandwidth, CPU and memory use in real time based on users' activities. System 100 may support a wide range of email clients to provide easy and user-friendly solutions for email forwarding of content files. Server 110 may include one or more Media management modules to support a plethora of video codec types, windows files and executable software and games on all Windows operating systems, thereby enabling the delivery of a magnitude of customized data per user, for example, on a daily basis.

Server 110 may include a data analyzing component or module 140, which may be integrated with an existing data processing component and/or may be a dedicated component. Data analyzer 140 may analyze data, for example, content data and/or user data, and may enable generation of results relating to general and/or individual user usage patterns, system performance, and other suitable results. In one embodiment, data analyzer 140 may analyze usage data of individual users, and may generate a user profile according to the studied behavior. Server 110 may use such a user profile to provide content to such a user, such that the content selected to be distributed to the user will be customized for the user, based on past usage patterns.

In some embodiments server 110 may receive and/or send data from/to clients using XML. The server may keep track of every item that was downloaded by any client, so whenever the client requests new items, it receives only items were not previously received.

Network 145 may include any data networks, including the Internet, Intranets, Extranets, wireless data networks, other suitable networks, or combinations of networks.

Filtering engine 135 may enable automatic or semi-automatic reviewing and aggregating of content data, to ensure, for example, quality control, accurate indexing, filtering etc. In one example, filtering engine 135 may manage a filtering process such that content being distributed to all requesting clients is first verified. In one example, filtering engine 135 may receive new content data (e.g., content added into the system by one or more users), and may forward the new data to users who have been defined or defined themselves as reviewers or censors. These reviewer users may review new content and assign definitions, categories, rankings etc. to the new content, in one or more review rounds, as defined by one or more content review programs or algorithms. Review users may also add content, delete content, provide comments, keywords etc. Filtering engine 135 may provide the new content to the system only after the new content definitions, categories, rankings etc. have been assigned by the review users. In other examples content may be filtered by system managers, external reviewers or other selected parties.. In such a way, content may be automatically, manually or semi-automatically reviewed, censored, removed etc. from the system according to selected filtering formulas For example, the review may be conducted by the community of users themselves. Server 110 and/or filtering engine 135 may receive the feedback from the review users, may aggregate, calculate, analyze or otherwise process the feedback and may make automated, semi-automated and/or non-automated decisions whether to allow the content to be available to other users.

User computers may include clients applications 160 may include an upgrade manager 170 to enable management and updating of updated applications, software, data etc. Client application 160 may include a download manager 175 to manage the downloading of content and data from other clients and/or server 110. Downloader 175 may, for example, send updates to a download helper application regarding its progress. With every message, it may send, for example, action and code parameters in the query string. In one example, data reported by downloader 175 may be processed by cronjob and loaded to appropriate tables. For example, the user's visitID may be retrieved from a cookie. The Downloader may use WinInet to send its updates, so the visitID cookie may be sent only if the user used Internet Explorer to visit the site, and only if he/she has cookies enabled. The downloader may perform the following actions in the following order: extract the DllDownloader.dll (from its own binary resource area) to the Temp folder of the running PC; try to locate the RunDll32.exe in the System32 folder or the Windows folder; if found, add an execution link to the Startup folder and execute the main function of DllDownloader.dll through the RunDIl32.exe; otherwise, execute the main function of DllDownloader.dll through the Downloader process itself.

Client application 160 may include an application agent 180, which may detect when the user's machine is idle. When idle state is detected (e.g., the user is away from his/her machine), agent 180 may automatically launch the client application, for example, to order, request and/or download new items. The number of new items that are downloaded for each channel may be limited to a pre-defined number. Agent 180 may be started, for example, from the Windows startup menu, and may be displayed and launched from the SysTray Icon on windows. Other suitable launching and displaying locations may be used. Agent 180 may be activated, for example, when the system is idle. In one embodiment the agent process may consume about 3-6 MB of memory, as heavy memory usage may be avoided when some or all the functionalities of client application 160 are not needed. In case the client application 160 (e.g., exe file) is activated and agent 180 is not active, agent 160 may be activated. In one embodiment the launching process cannot be run more than one time.

Agent 180 may enable one or more of the following functions: Monitor idle time; in case the user retuned to work and the idle time is completed, the application may be terminated by the agent; indicate waiting items; display the number of waiting items in the sys tray icon; receive data from the application process; if the application process is not active, this data may be read from the registry; if this is the first time that the agent opens the application main window, it may run a splash screen; after the first activation, the splash screen may not appear as long as the agent still exists in memory; enable a right click option to enable/disable right click options according to the modal state of the main application window; enable a new items alert, for example, if the user returned to the client application after it has been idle, and there are new items waiting, a balloon or other suitable alert may be displayed to notify the user. The alert may be displayed only once per day even if there will be more idle time terminations, according to the user's preferences.

Client application 160 may include a transport engine 185 to manage data transfers, between client application 160 and server 110, and/or between a plurality of clients. Client application 160 may include a dedicated or non-dedicated local database 187 to store relevant data. For example, the client application may maintain copies of downloaded items in local database 187. In one embodiment transport engine 185 may enable delivery of requested files to a user's local machine using Peer downloading. For example, transport engine 185 may include a peer-to-peer engine, for example, to enable direct or peer to peer data sharing and/or file transfers between client computers (e.g., users may share local content files with other users or peers who are interested in the content items). In one embodiment transport engine 185 may enable delivery of requested files to a user's local machine using Web downloading.. For example, the client Application 160 may be configured to initially attempt to download a requested file from another system user or peer. If for some reason the download fails, then the file may be downloaded using a web download engine (e.g., from server 110), for example, using HTTP.

According to some embodiments of the present invention, system 100 may enable automated or semi-automated “floating” up or “pushing” of filtered content to community members. In one example of data transfers, copyrighted content protected by DRM may be distributed with consumption rules, for example, prohibiting extended use of music, videos, software and games etc. without payment. System 100 may enable pushing of content to users thereby overcoming the delays typically caused by download times.

System 100 may enable pushing of data, from server 110 and/or from client application 160, to users during the time in which a user's computer is not processing other data or running other applications etc., thereby minimizing waiting time, maximizing network bandwidth etc. For example, pushing of data may enable distribution of content beyond typical data limits (e.g., providing full screen DVD quality commercials, clips etc.), providing advertisements in the context of the selected clips etc. In some embodiments, communications with the client application may be XML based (SOAP) and/or HTML based (e.g., for embedded browsers).

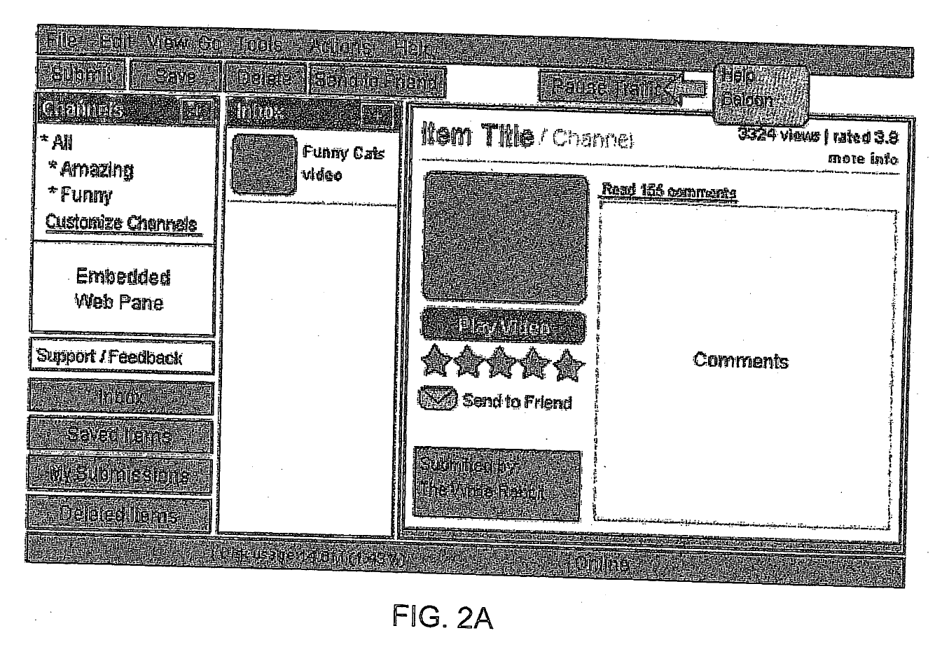

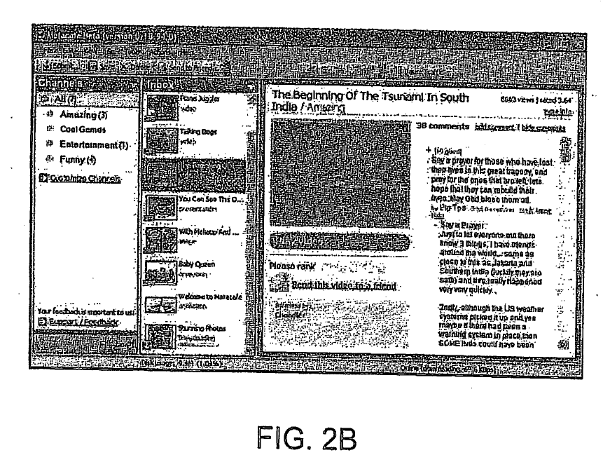

Client application 160 may be launched or started from, for example, the windows startup menu, and may be displayed in the SysTray Icon in the Windows environment, or in other suitable places in other computing environments. The client application may be activated, for example, when the system is idle. Client application 160 may include a Graphic User Interface (GUI) 165 dedicated to executing the functions and controls to interact with system 100. An example of a user interface may be seen with reference to FIGS. 2A and 2B. For example, as can be seen in FIGS. 2A and 2B, when the user clicks on an item from the item list the information on this item may be displayed in the main pane. The user may see the item's title, channel, description, thumbnail, number of viewers, current rating, submitter and user comments, as well as the item file-type, file-size, length & resolution etc. Tie user may Play/View the item as well as rank, delete, save and send this item to contacts by email. Items may be distributed between users using a user's email client (e.g. Outlook Express) or using the system server(s).

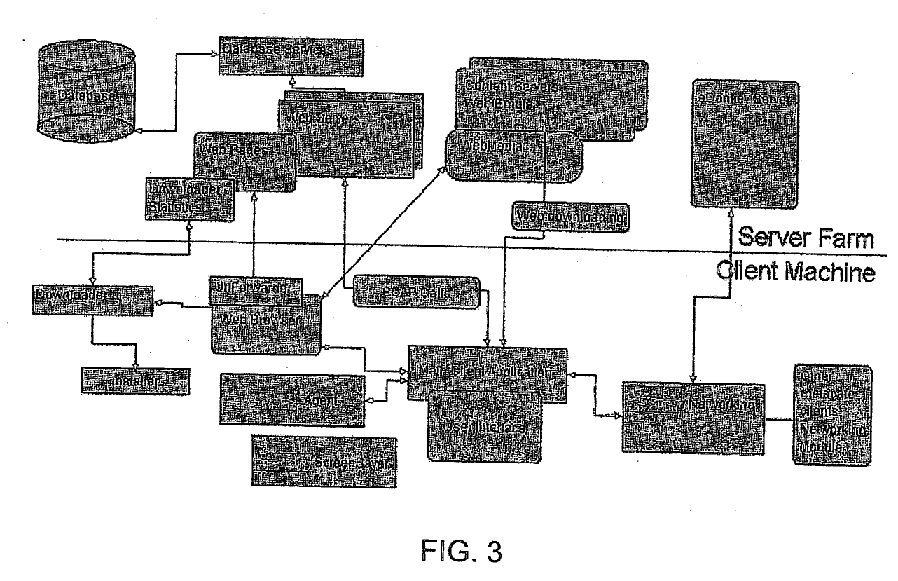

According to some embodiments of the present invention, as can be seen with reference to FIG. 3, server 110, which may be part of at least one server farm, may be connected to one or more client machines, each client machine including client application 160. Server 110 may include database services 210, which is a layer which may include the relevant SQL tables in the MySQL Database, DBLayers for the Player, Admin, CronJob etc. and other suitable table and procedures. Server 110 may include Web pages 215, for example, standard HTML pages, Embedded HTML pages, and non-HTML pages. Server 110 may include a closed-source P2P application server, for example, an eDonkey server or other suitable servers.

In some embodiments client application 160 may include installer 250. Client application 160 may include UrlForwarder 255, for example, to centralize the control over various web links accessed by the client application. In one example, all of the links may be passed through a single link redirector. Client application 160 may include a screensaver 280, which may be a separate client process that presents application items when the machine is idle. Client application 160 may-include a networking application or emule 270. Networking application 270 may enable, for example, external control over the traffic and/or for debugging purposes. Other client networking modules 275 may be used.

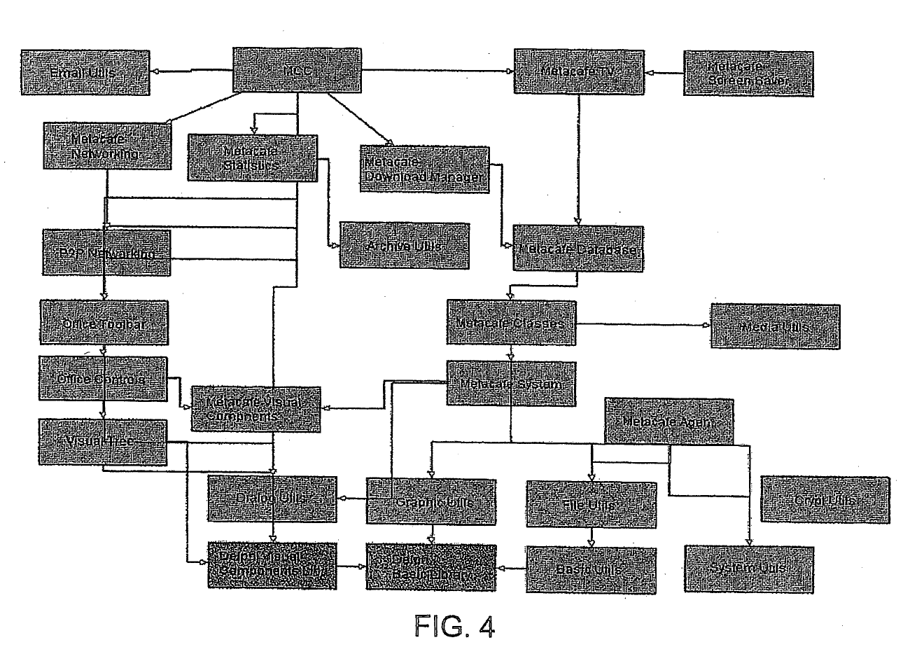

Reference is now made to FIG. 4, which illustrates an example of DII modules that may operate in the client application 160.. For example, MCC may be the main application, which may operate with several core modules including: email utilities—to send emails using the user's currently installed email client; a TV module (e.g., Metacafe TV)—to display videos and/or images on a users monitor (e.g., using a full screen); a screensaver—to display videos or other suitable content while the user machine is idle; a networking module (e.g., Metacafe Networking)—to manage the file transport; a statistics module (e.g., Metacafe Statistics)—to manage the reports to system server 110; and a download module (e.g., Metacafe Download Manager)—to mange downloading requests and operations. Other modules and/or sub-modules, as indicated in FIG. 4, and/or additional suitable modules and/or sub-modules may be used Further, other structures and dimensions may be used using any desirable combination of hardware and/or software may be used.

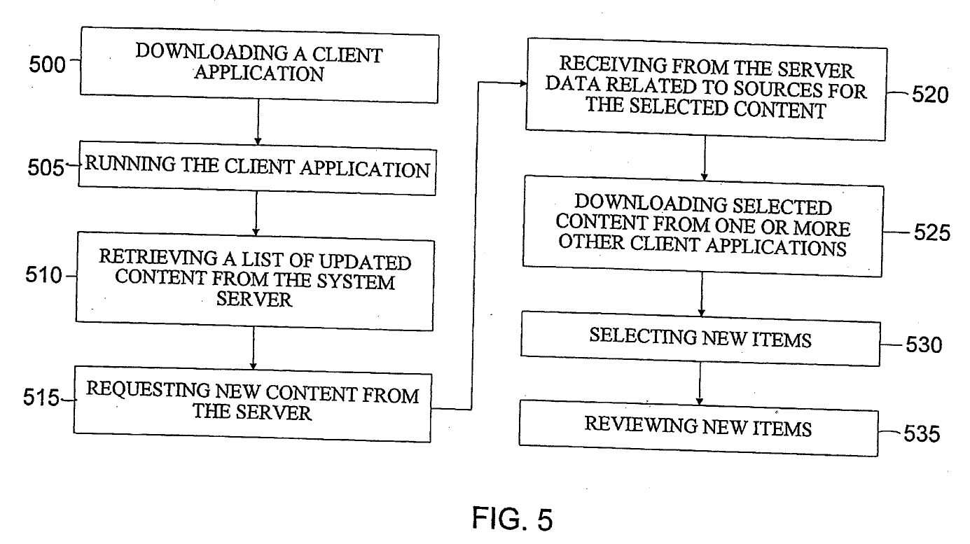

Reference is now made to FIG. 5, which illustrates an example of a process for setting up and executing the client application, according to some embodiments of the present invention. At block 500 a user may download a client application, for example, from a Website, or load an application onto a user computer using a CD.Rom etc. At block 505 a first user may run the client application, which may load onto the client's system. The client application may require of the user to register, open a user account, or otherwise sign up as a user. The registration may include provision of personal data, personal preferences etc. At block 510 the client application may connect to a system server to retrieve an updated list of content, for example, according to selected content channels, restrictions, rankings, types, keywords, formats, language, or other suitable criteria. At block 515 the client application may request new items or data from the system server, At block 520 the server may send data to the first user computer, including a list of client applications in the peer-to-peer network where the relevant content may be located (e.g., content sources).

At block 525 the client application of the first user may download the selected content from one or more other client applications where the relevant content is located. In some embodiments, for example if the content cannot be located in one or more other client applications, the client application of the first user may request to download the content data directly from the system server. At block 530 the user may select and view selected items. At block 535 the user may rank, review or otherwise comment on one or more items. In some embodiments, in addition to or in place of the user entering user preferences into the system, data analyzer component 135 in the server may enable distribution of selected content to a user based on the user's previous usage behavior.

Each user may be a potential contributor to the community, and may submit content to the system server and/or other users. When submitting a new item, for example, the submitter may specify, categorize or define the item's files, channels, filters, title, description and optional web links. The server and or client application may verify that none of the submitted files were previously submitted by another user, for example, by using an MD5 hashing or other suitable error checking mechanisms. In some embodiments the system server may receive, analyze, aggregate or otherwise process the client review, comments, rankings etc., and add relevant data to the respective items. This data may help rank, categorize, define, filter the content delivered within the community of users. Any combination of the above steps may be implemented. Further, other steps or series of steps may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A content distribution system, the system-including:
a system server to control the distribution of content to a plurality of user computers, said server including a push engine to enable automatic pushing of selected content between said user computers according to previously configured user preferences; and
a community of user computers, each said user computer including a peer-to-peer engine to facilitate peer-to-peer file transfers directly between said user computers, each said user computer further including a client application to enable said peer-to-peer file transfers to be managed by said system server such that selected content is pushed between said user computers according to said previously configured user preferences.

2. The content distribution system of claim 1, wherein said system server is to enable automated filtering of said content.

3. The content distribution 'system of claim 1, comprising a community managed content reviewing mechanism to enable the reviewing of new content received and the automatic distribution of said new content to said user computers only if selected criteria are met.

4. The content distribution system of claim 1, comprising a content ranking mechanism to provide updated rankings for content, said rankings being used to determine whether said content is to be distributed to said user computers, according to said previously configured user preferences.

5. The content distribution system of claim 1, wherein said previously configured user preferences include one or more preferences selected from the group consisting of channels, restrictions, rankings, types, keywords, formats, and language.

6. The content distribution system of claim 1, wherein said server includes a data analyzer to enable control of said distribution of content according to individual user behavior.

7. A method for digital content distribution, the method including:
entering user preferences to a server computer, said preferences for filtering content to be received by said user in a peer-to-peer network;
requesting content files from said server computer, by a client application on a user computer, according to said user preferences;
sending to said user computer data including a list of selected content to be sent to said user computer; and
pushing said selected content to said user computer from one or more other user computers, according to said previously configured user preferences.

8. The method of claim 7, comprising reviewing new content before pushing said content to said user computer, and automatically distributing reviewed content to said user, if said reviewed content fulfills selected criteria.

9. The method of claim 7, comprising filtering said content data by said server computer.

10. The method of claim 7, comprising analyzing said content data by said server computer.

11. The method of claim 7, comprising analyzing said user behavior by said server computer, and determining which content is to be distributed to a selected user based on said behavior analysis.

12. The method of claim 7, comprising pushing targeted advertisements to said users.

13. The method of claim 7, comprising ranking said content by said users, said rankings being used to determine whether content is to be received by said user, according to said previously configured user preferences.

14. The method of claim 7, wherein said pushing said requested content to said user computer is implemented when said user computer is idle.

15. The method of claim 7, comprising pushing said selected content to said user computer based on previous user behavior.
